(19) United States
(12) Patent Application Publication
(10) Pub. No.: US 2018/0365761 A1
(43) Pub. Date: Dec. 20, 2018

(54) PLATFORM FOR FINANCING HEALTHCARE SERVICES

(71) Applicant: Mark G. FONTENOT, Lafayette, LA (US)

(72) Inventor: Mark G. FONTENOT, Lafayette, LA (US)

(21) Appl. No.: 15/870,584

(22) Filed: Jan. 12, 2018

Related U.S. Application Data
(63) Continuation of application No. 13/047,976, filed on Mar. 15, 2011.
(60) Provisional application No. 62/445,471, filed on Jan. 12, 2017.

(51) Int. Cl. G06Q 40/00; G06Q 10/10; G06Q 40/02

(52) U.S. Cl. CPC G06Q 40/00; G06Q 40/025; G06Q 10/10

(57) ABSTRACT

Embodiments described herein include systems and methods for financing amounts and account balances relating to healthcare services and goods. The system receives provider data from providers, including healthcare providers. The provider data from each provider includes patient account data corresponding to patients, and provider financial parameters. Financial data is received from financial entities, and the financial data from each entity includes financial product data, and qualification parameters. The system aggregates the data by aggregating the provider data and the financial data, and determines from the aggregated data a set of patients. Each patient of the set of patients corresponds to an account balance with a healthcare provider. The system generates from the aggregated data settlement options for resolving each account balance of the patients. The settlement options include payment options and/or financing options. The system controls access by patients to the settlement options and corresponding financial entities.

### RELATED APPLICATIONS

This application claims the benefit of United States (U.S.) Patent Application No. 62/445,471, filed Jan. 12, 2017.

This application is a continuation in part application of U.S. patent application Ser. No. 13/047,976, filed Mar. 15, 2011.

### TECHNICAL FIELD

Embodiments are described relating to systems and methods for resolving balances relating to healthcare services and, more particularly, financing costs of healthcare services and goods.

### BACKGROUND

Consumers and Patients (CP) are often faced with out-of-pocket payments to cover healthcare services. There is a need for a Platform configured for use by healthcare Providers and/or CPs to assist with payment of expenses relating to healthcare services.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a flow diagram for the Platform configured for financing balances relating to healthcare services and goods, under an embodiment.

FIG. 2 is a flow diagram for Platform operations with a CP seeking a financing solution for a healthcare balance, under an embodiment.

FIG. 3 is a flow diagram for the Platform configured for aggregating CP healthcare balances and matching the aggregated portfolio of healthcare balances with a credit facility, under an embodiment.

FIG. 4 is a flow diagram for the Platform configured for financing healthcare balances with use of medical savings account (e.g., Health Savings Account) access, under an embodiment.

FIG. 5 is a block diagram of the Direct Consumer Debt Revenue Cycle (DCDRC) enabled by the Platform, under an embodiment.

FIG. 6 is a block diagram of the Patient Financing System (PFS), under an embodiment.

FIG. 7 is a flow diagram for Selective Processing of the PFS, under an embodiment.

FIG. 8 is a flow diagram of FICO Score Filtering of the PFS, under an embodiment.

FIG. 9 is a flow diagram of unbundling and selective processing of healthcare treatment plans using the PFS, under an embodiment.

FIG. 10 is a block diagram of a dental service example using the eDentaFi dental revenue cycle combining DIRC and DCDRC enabled by the eDentaFi platform, under an embodiment.

### DETAILED DESCRIPTION

Systems and methods for financing amounts and account balances relating to healthcare services and goods are described. A Platform and Patient Payment Portal (“Platform”) is described that is configured to receive from healthcare Providers prospective, current, past due, and bad debt-related account balances of their patients into the Platform for at least partial settlement as described herein. The healthcare Providers include one or more of physicians, doctors, dentists, licensed healthcare providers, hospitals, and therapists (collectively referred to as Providers) that deliver healthcare and healthcare-related services and goods to CPs, but are not so limited. The Platform is configured to aggregate information received from the Providers and their accounts receivable (A/R) data as well as sources of financial products. The Platform is configured to determine on behalf of CPs if they have an outstanding balance with any Provider(s), identify and present at least one of payment and financing options for outstanding balances, and identify any available payment and/or financing options for application towards anticipated healthcare encounter-procedure.

In the description herein, numerous specific details are introduced to provide a thorough understanding of, and enabling description for, embodiments of the PFS. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

Embodiments described herein generally include systems and methods for financing amounts and account balances relating to healthcare services and goods. The system receives provider data from providers, including healthcare providers. The provider data from each provider includes patient account data corresponding to patients, and provider financial parameters. Financial data is received from financial entities, and the financial data from each entity includes financial product data, and qualification parameters. The system aggregates the data by aggregating the provider data and the financial data, and determines from the aggregated data a set of patients. Each patient of the set of patients corresponds to an account balance with a healthcare provider. The system generates from the aggregated data settlement options for resolving each account balance of the patients. The settlement options include payment options and/or financing options. The system controls access by patients to the settlement options and corresponding financial entities.

More particularly, the Platform is configured for access by CPs to determine or identify an outstanding balances they have with any Provider(s), review financing options for any outstanding balances, determine if they quality for financing to pay for healthcare services, and/or obtain any financing for which they qualify. The Platform is configured to enable CPs to efficiently provide or complete the information for self-authentication allowing the Platform to measure credit worthiness (e.g., FICO scoring, other financial information, etc.), and match the CP's level of credit worthiness to financial services available via the Platform. This eliminates having the CP complete a credit application for each financial service.

The Platform is configured so a CP gains access via a portal and authenticates their identity by entering at least a portion of CP identification information. The CP identification information includes but is not limited to at least one of full name, address (current and/or past), Social Security number, government issued identification number (e.g., Passport, Driver License, etc.), Provider Reference Number, Health Insurance Policy Number, place of employment, and annual income. The Platform is configured to at least one of store and compare the information received through the portal against information supplied to the Platform or accessed by the Platform (e.g., CP's Provider tendering a Reference Number specific to the CP and balance or anticipated healthcare encounter information, data and/or FICO scoring from at least one credit reporting agencies (CRA's), etc.).

If the Platform comparison results in a match then the CP is authenticated and, once authenticated, can access via the Platform any prospective balances from anticipated healthcare encounters, current healthcare balances, and past due and bad debt patient balances relating to healthcare. Furthermore, the Platform is configured to provide or control access by the authenticated CP to any financial services (according to CP creditworthiness), and match and pre-qualify the CP for financial services based on their information (e.g., identification information, financial information, FICO score, etc.). The Platform is configured for a CP to review any payment options for current, past due, and bad debt healthcare balances. Additionally, the CP can also seek to open a medical savings account (e.g., using the Platform, etc.), and/or seek financing to contribute to a newly opened medical savings account or contribute loan proceeds to an existing HSA.

As an example, a patient is scheduled to undergo total knee replacement surgery and their co-pay and deductible due is $5,000. Before the procedure, the Provider may require the patient to pay the $5,000 co-pay and deductible. If so, the Provider can send the CP financial information to the Platform. The CP can access the Platform, provide their personal or identification information including information to be FICO scored, view matching financial services based on credit worthiness, and select a financial services to finance anticipated total knee replacement procedure. In particular, according to the credit worthiness of the CP, the CP can review a myriad of financial services and can be matched and/or pre-qualified for financial services based on their FICO score or other means to measure credit worthiness. After selecting an available financial service, the CP can complete any additional information. After approval, the loan proceeds can be sent to the CP to be disbursed to the Provider or the loan proceeds can be sent to the CP's Provider (and, in the example, the hospital).

The Platform of an embodiment is configured to receive provider data from providers, including healthcare providers. The provider data from each provider includes patient account data corresponding to patients, and provider financial parameters. The Platform of an embodiment is further configured to receive and/or store data of selected financial services of various capital providers and credit facilities. The system aggregates the received data by aggregating the provider data and the financial data. In an embodiment the Platform generates a database including the aggregated data, but the embodiment is not so limited. The system generates from the aggregated data settlement options for resolving each account balance of the patients. The settlement options include payment options and/or financing options. For example, the Provider may accept a loan wherein the Provider will pre-pay interest in the form of a discount. In the $5,000 co-pay and deductible, if the interest is $1,000 over the term of the loan, then the Provider would accept $4,000 ($5,000 less $1,000 pre-paid interest). These types of financial services help CP's secure financing that are often considered risky and are often associated with low FICO scores.

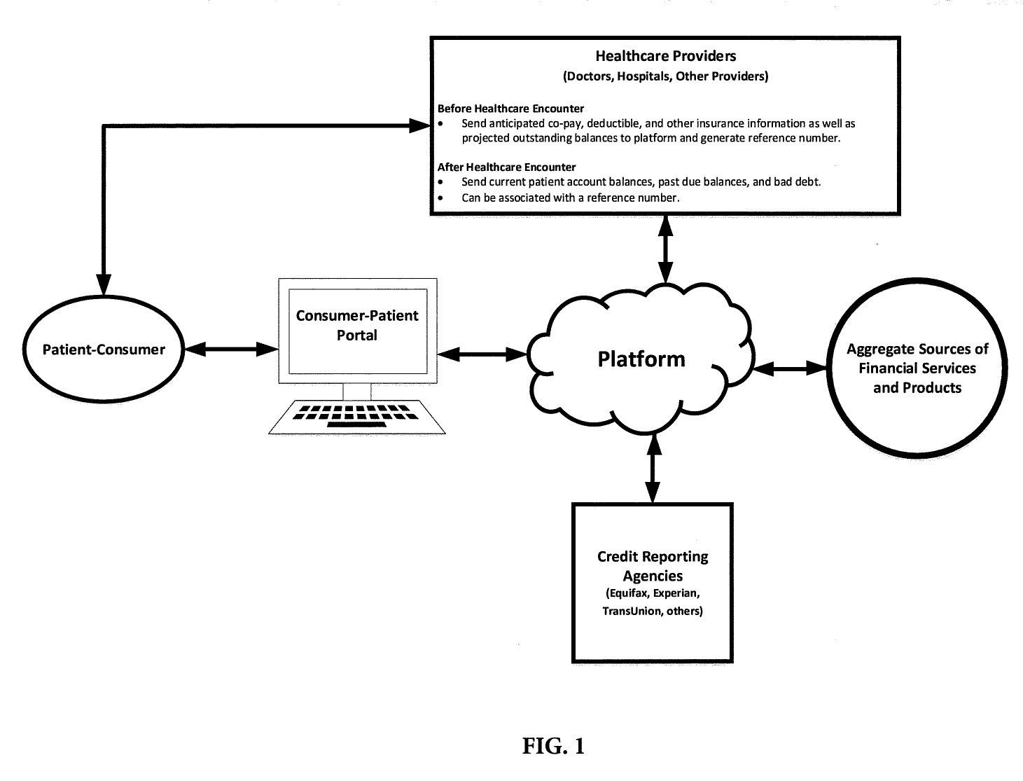

FIG. 1 is a flow diagram for the Platform configured for financing balances (e.g., anticipated, current, past due, bad debt, etc.) relating to healthcare services and goods, under an embodiment. Operations for which the Platform is configured include CPs accessing the Patient Portal (PP) via a computing device (e.g., smart phone, tablet computer, personal computer, uniform resource locator (URL), etc.). The CPs provide or enter identification information to identify themselves, for example, in one or more Credit Reporting Agencies (CRAs) (e.g., Experian, Equifax, TransUnion, etc.). The CP identification information includes one or more of name, current address, past address, date of birth, employment data, income data, Social Security number, identification card number (e.g., driver license number, passport number, government identification, etc.), insurance policy of identification number, and/or other identifying information for example, but is not so limited. In response to provision of the CP identification information, the CRA returns CP information and CP confirms accuracy of the information (self-authentication).

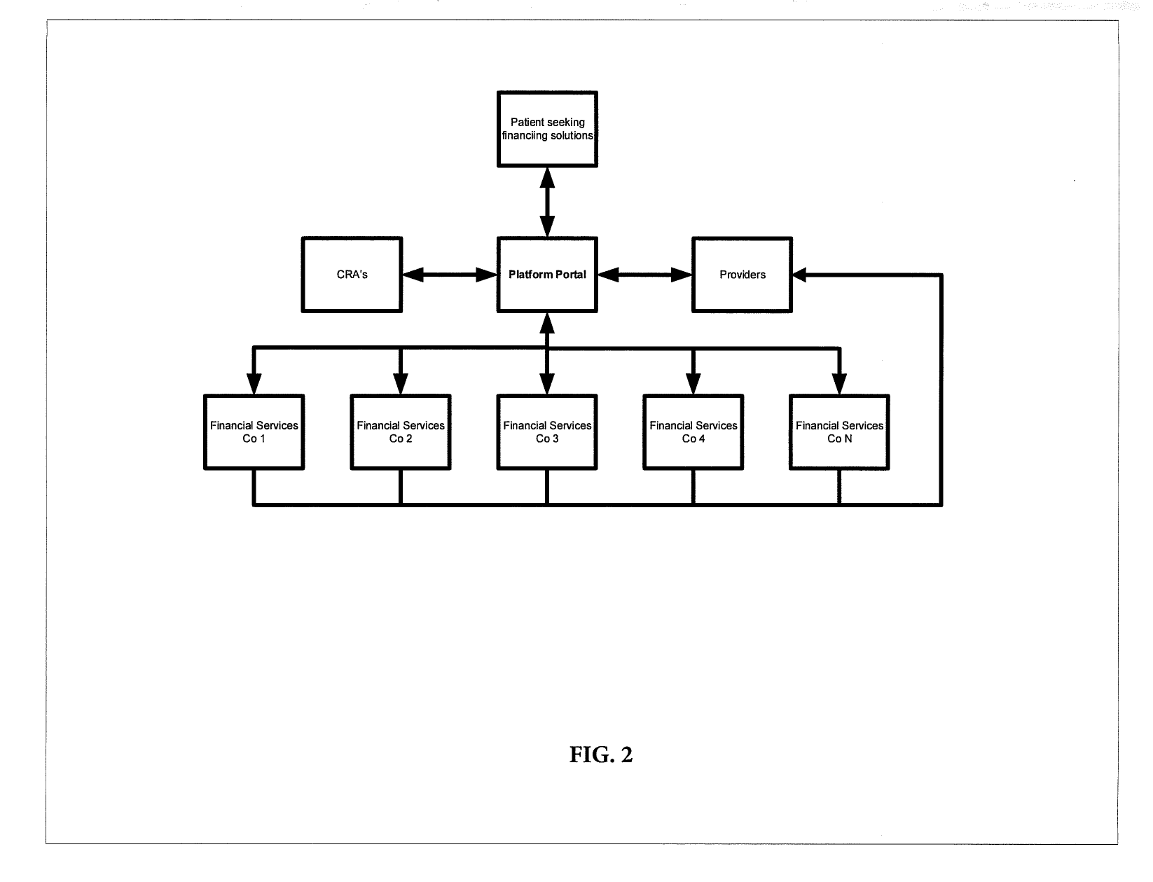

FIG. 2 is a flow diagram for Platform operations with a CP seeking a financing solution for a healthcare balance, under an embodiment. As described herein, the CP accesses the Platform and tenders identification information. The Platform is configured to access one or more CRAs using the identification information, and the CRA returns a FICO score and lends insight into patient's credit worthiness, for example. The Platform matches financial solutions to credit worthiness and/or matches financial solutions approved by Provider to patient's credit worthiness.

After CP confirmation of CRA information (along with any consents), self-authenticated information is used to search, for example, a database for account data including prospective, current, past-due, and/or bad debt credit balances that are listed in the database, and return amounts if search is positive. An example database configured for determining outstanding patient balances is CirraCheck provided by CirraGroup, Lafayette, La. The CP can also determine if they qualify to finance debt or outstanding balances.

Furthermore, following confirmation of CRA information (along with any consents), the Platform is configured to use the self-authenticated information to identify or determine financial services corresponding to the CP based on the CP's credit worthiness. The CP can determine their credit worthiness (e.g., FICO score, etc.), and view available financial services based on their credit worthiness. If a CP qualifies for financing then the Platform is configured to control obtaining of the credit so the CP selects the financial service, is made aware of any additional information necessary to complete the financing, and receives loan proceeds and/or directs loan proceeds to the Provider.

Providers have the option to send financial information surrounding an anticipated CP's healthcare encounter to the Platform. Providers can also send accounts receivable data such as current, past due, and bad debt healthcare balances to the Platform. For example, if the co-pay and deductible for a total knee procedure is $5,000, this financial information would be sent along with patient name and Social Security number. The hospital could also give the patient a reference number and URL and have the patient determine if they qualify for financing. Provider can send current, past due, and bad debt balances to the Platform allowing CP's to access the Platform and determine if CP's has outstanding balances. For any other anticipated elective procedures, patient can enter PP to determine if they qualify for financing.

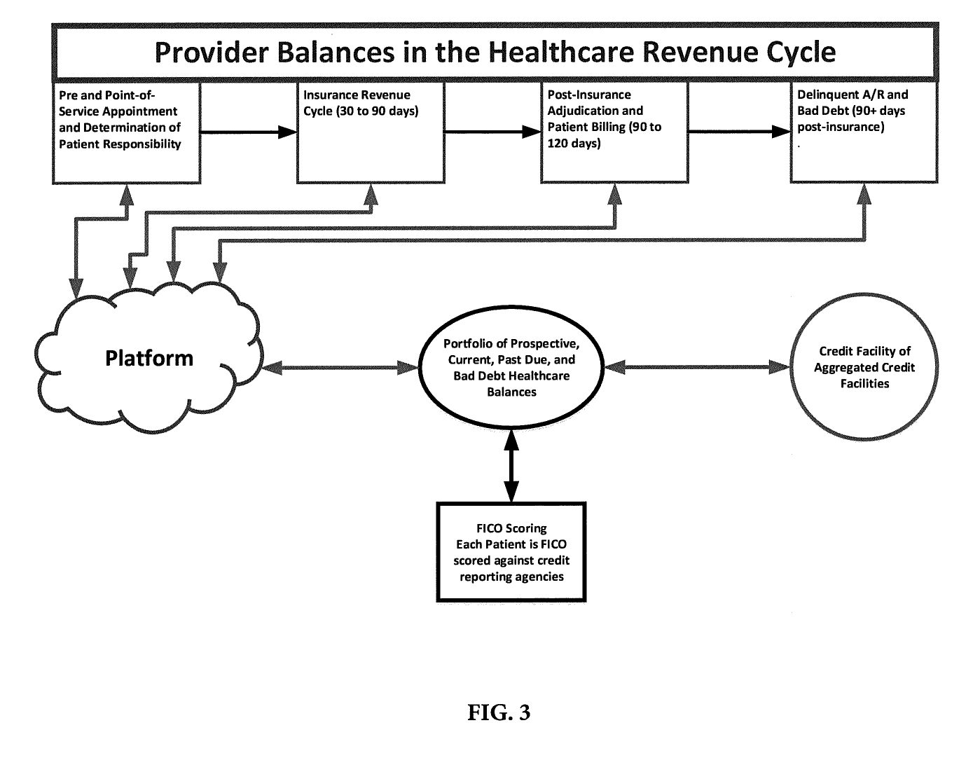

FIG. 3 is a flow diagram for the Platform configured for aggregating CP healthcare balances (e.g., anticipated, current, past due, bad debt, etc.) and matching the aggregated portfolio of healthcare balances with a credit facility to finance at least a portion of the balance, under an embodiment. The Platform is configured to aggregate balances of patients of healthcare Providers, where the balances include one or more of prospective, current, past due, and bad debt balances. The Platform is configured to match the aggregated portfolio balances with one or more credit Providers or facilities in order to finance some or all of the CP's balance. The Platform therefore enables Providers such as hospitals to efficiently identify financing of their healthcare receivables.

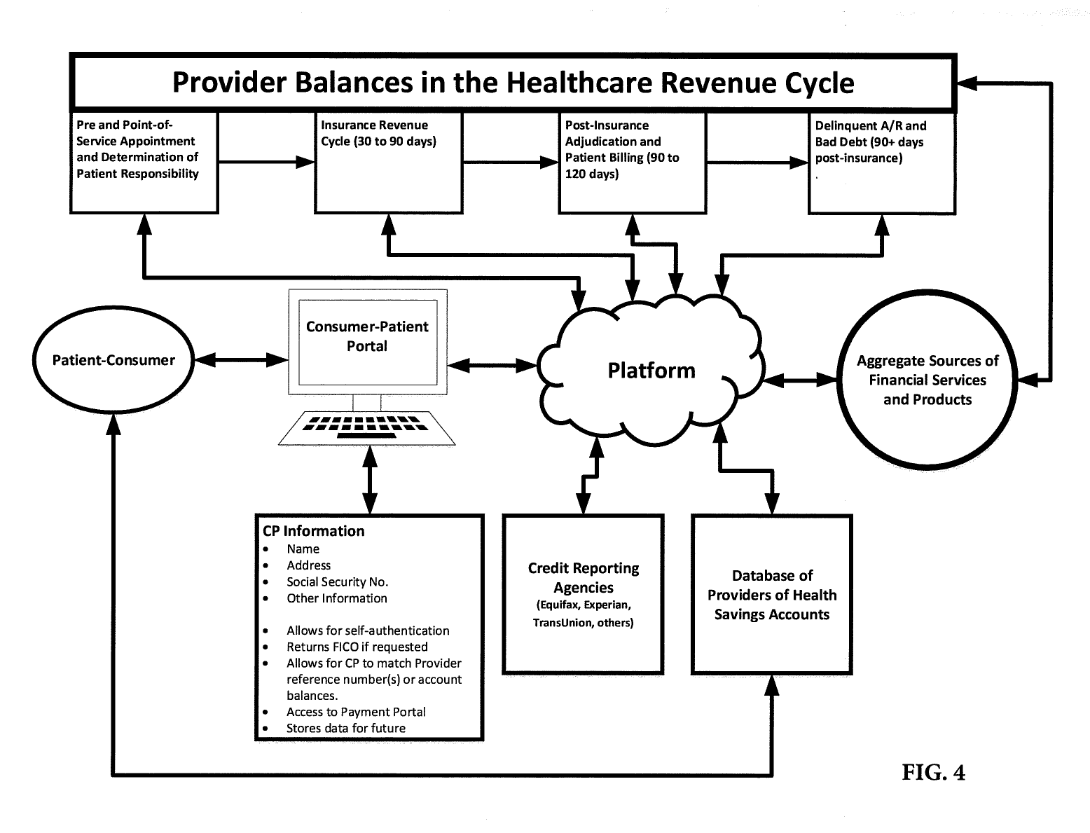

If the CP qualifies for financial services, the Platform is configured to match financial qualifications to a Heath Savings Plan, and to enable the patient to finance payment proceeds into their medical savings account (e.g., HSA, etc.). Further, the Platform is configured for use by a patient in selecting and opening a medical savings account and depositing the loan proceeds until such time as they are withdrawn to pay for healthcare services. FIG. 4 is a flow diagram for the Platform configured for financing healthcare balances (e.g., anticipated, current, past due, bad debt, etc.) with use of medical savings account (e.g., HSA, etc.) access, under an embodiment. The healthcare balances include one or more of anticipated, current, and past due balances, but are not so limited. The Platform of an embodiment is configured for use by a patient in directing payment of funds from a medical savings account to a provider to satisfy at least a portion of an account balance.

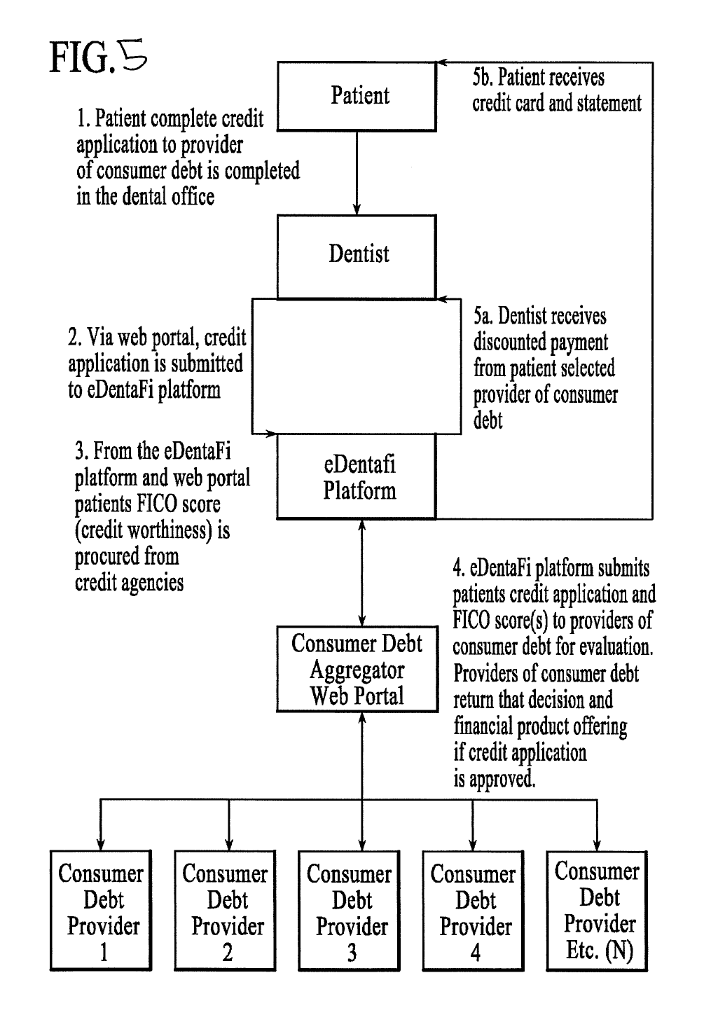

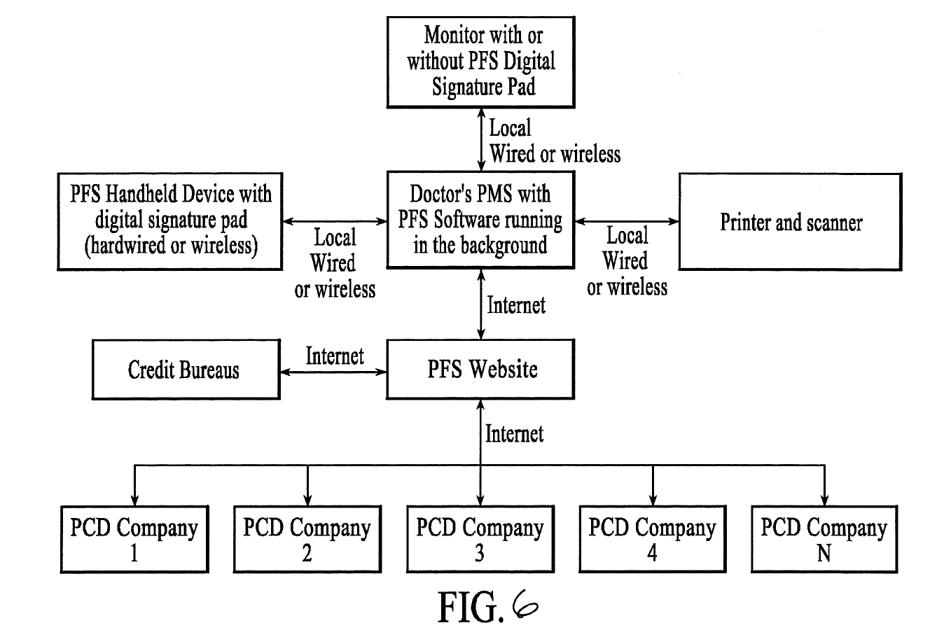

Alternative embodiments of the systems and methods for financing amounts and account balances relating to healthcare services and goods are described below. FIGS. 5 and 6 are exemplary block diagrams of the Patient Financing System (or sometimes referred to as the Direct Consumer Debt Revenue Cycle or DCDRC)) enabled by the Platform, under an alternative embodiment. The Platform is electronically coupled to one or more computers or systems at a provider or treatment facility (e.g., doctor, dentist, etc.), and to third-party consumer debt providers via a consumer debt aggregator portal. In an alternative embodiment, a patient using a personal computer may be provided access to the Platform to complete an application in advance of visiting the doctor. The coupling includes any type or combination of network technologies.

Embodiments of a Patient Financing System (PFS) are described herein. The PFS comprises one or more of Platforms, systems, devices, applications or software, and an electronic site on the World Wide Web that collectively enables the electronic coupling or connection of healthcare providers, and/or patients to a spectrum of consumer debt (PCD) financing companies offering finance products to healthcare patients wanting or needing credit to pay for out-of-pocket costs for healthcare treatment. Consequently, the PFS provides processes that efficiently and electronically facilitate the communication between patients and PCD financing companies, thereby providing the best opportunities for patients seeking financing of healthcare procedures.

The systems and methods of the PFS include, in an embodiment, a network-based electronic infrastructure for coupling or connecting patients to a spectrum of PCD financing companies. The network of an embodiment includes public networks like the Internet, but can include private networks instead of or in addition to the public networks. The systems and methods described herein include and/or run under and/or in association with a processing system embodied in the PFS. The processing system includes any collection of processor-based devices or computing devices operating together, or components of processing systems or devices. As such, the PFS of an embodiment includes a PFS Platform and PFS Website that for example, remotely and electronically couples or connects treatment facilities or healthcare providers (e.g., medical doctors, dentists, etc.) and their patients to multiple PCD financing companies. The PFS Platform therefore provides patients with an optimal opportunity for financing of healthcare procedures given the credit worthiness of the patient.

FIG. 6 is a block diagram of the Patient Financing System (PFS), under an embodiment. The PFS of an embodiment includes the PFS Platform and PFS Website. The PFS Platform runs remotely (e.g., web-based, application service provider (ASP), etc.) and is coupled or connected to a healthcare provider (e.g., treatment facility, hospital, doctor's office, etc.) and the facility patient management system (PMS), credit bureaus, and PCD companies. A healthcare provider, as the term is used herein, refers to one or more of treatment facilities, hospitals, doctors, and dentists, but is not so limited. The PFS also comprises PFS Software or Applications that run locally, for example, in the background of the healthcare provider practice management system (PMS), but the embodiment is not so limited. The PFS of an embodiment also includes a PFS Handheld Device (HHD) that can be coupled or connected via a wired and/or wireless coupling to the computer system at the healthcare provider. The PFS HHD comprises one or more of a keyboard, digital signature entry and capture device or component, LCD touch screen, PFS Software, and connectivity to the PFS Platform/Website via the network (e.g., Internet, etc.). The PFS also comprises a PFS Digital Signature Pad for accepting a patient's signature.

The PFS Software and graphic user interface (GUI) allows the healthcare provider to specify their approach to helping patients procure financing of medical or healthcare provider procedures using PCD financing. There are numerous credit application options and/or strategies that the healthcare provider and/or patient can select via the PFS including, but not limited to, the following: sending the PFS credit application form (CAF) to all PCD companies; selecting specific PCD companies to direct the patient's PFS CAF; sending the patient's PFS CAF based on the patient's FICO score, wherein the patient's FICO score meets or exceeds the minimum funding FICO score for PCD financing companies; and, unbundling treatment plans into smaller treatment plans for financing by more than one PCD financing company.

The PFS streamlines the process of seeking financing by healthcare providers and their patients. In particular, the PFS comprises a PFS CAF that electronically imports patient name, address, and other information from the healthcare provider PMS and automatically populates the PFS CAF using the imported PMS data or information. The patient can review a digital copy of the PFS CAF on a computer monitor or PFS HHD. Alternatively, the PFS CAF can be printed, reviewed, and in some cases signed, then the paper CAF can be converted to an electronic format (e.g., digitized) and converted via the PFS into the PFS CAF digital format. Corrections or additions to the PFS CAF can be made and the patient can use the PFS digital signature pad locally connected to the healthcare provider's computer system and usually alongside the monitor or the PFS HHS digital signature capture capabilities.

The signed PFS CAF is uploaded to the PFS Platform or directly to the PFS Website and is ready to be processed through the PFS Platform/Website to the aggregated PCD financing companies. According to the needs of the patient, the PFS GUI allows the healthcare provider's office to choose Selective or Non-Selective processing of the patient's PFS CAF to the aggregated PCD financing companies connected to the PFS Website, as described in detail below.

In general, Non-Selective processing of the PFS of an embodiment electronically pushes the patient PFS CAF (Jane Smith for example) downstream via the network or internet to the credit bureaus to capture the patient FICO score, then to all of the PCD financing companies for review of the patient's credit worthiness using the PFS CAF and the captured FICO score. In some cases, PCD financing companies require the CAF in the PCD specific format. The PFS Platform comprises templates to convert the PFS CAF to a CAF specific to the PCD financing company.

Non-Selective processing of the PFS of an alternative embodiment electronically pushes the patient PFS CAF downstream via the network or internet to the PCD financing company, which in turn, procures the patient FICO score. The PFS Platform comprises templates to convert the PFS CAF to a CAF specific to one or more recipient PCD financing companies.

The PCD financing companies return a decision of whether or not to extend credit after reviewing the patient CAF received via the PFS. These decisions by the PCD financing companies are shown or presented by the PFS Website when logged into the PFS Website, wherein the financing decisions are displayed on a computer monitor or PFS HHD. In the cases where credit is extended, the terms of the underlying credit products are displayed for the patient and/or healthcare provider to select.

When a patient selects a credit provider (or PCD financing company), the patient signs a PFS credit acceptance form using the PFS digital signature pad, and the signed PFS credit acceptance form is electronically sent to the PCD financing company. Similar to the PFS CAF and mapping of the PFS CAF to specific PCD financing company's CAF, the PFS comprises templates to map the PFS credit acceptance form to PCD financing companies' credit acceptance form. The PCD financing companies that approved credit for the patient but were not selected by the patient can be notified of the patient's decision electronically via the PFS. Alternatively, the healthcare provider can first view the finance products as result of the PCD financing companies accepting the patient's credit application and select the appropriate finance product before the patient selects the final finance product.

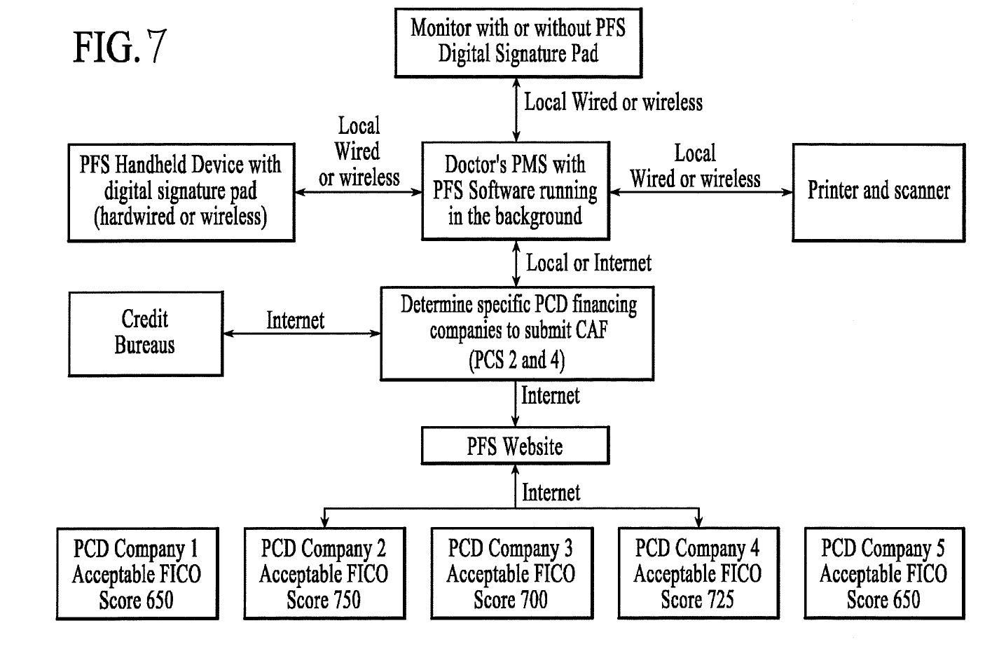

In general, the Selective processing of the PFS of an embodiment allows the patient or healthcare provider in the treatment example herein to electronically direct the patient's PFS CAF to specific PCD financing companies. FIG. 7 is a flow diagram for

Selective processing of the PFS, under an embodiment. For example, with the patient's consent, the healthcare provider desires to submit the patient PFS CAF to two particular PCD financing companies, and the healthcare provider selects the appropriate PCD financing companies with which to begin processing.

In an embodiment of the PFS, the patient's FICO score is procured once from one or more credit bureaus, electronically attached or integrated into the patient's PFS CAF, and selectively or non-selectively transferred electronically to PCD financing companies aggregated on the PFS Website. Using the PFS, a patient's credit application along with a set of FICO scores and an amount to be financed is provided to one or more PCD companies based on a number of parameters including but limited to FICO score, amount to be financed, and combination of FICO scores. The PFS therefore enables unbundling of healthcare treatment plans into incrementally smaller and less expensive treatment plans, such that credit applications can be transmitted to one or more PCD companies for financing of each unbundled healthcare treatment plan.

In an alternative embodiment, the FICO score is procured by having the patient complete the PCD CAF via the PFS Platform. The PFS software imports the patient's information (e.g., name, address, occupation, social security number, etc) from the healthcare provider's practice management system. The patient reviews the PFS CAF for correctness and completes or provides any missing information. The patient selects the PCD financing company or companies through the PFS Platform. The PFS software includes a template to convert the PFS CAF to the PCD company-specific CAF. The patient signs or approves the PCD financing companies using the PFS digital signature pad or prints the CAF and signs the paper CAF, which could then sent via facsimile or email in PDF format. Under this alternative embodiment, the PCD financing sends or transfers the patient's information to a national credit bureau(s).

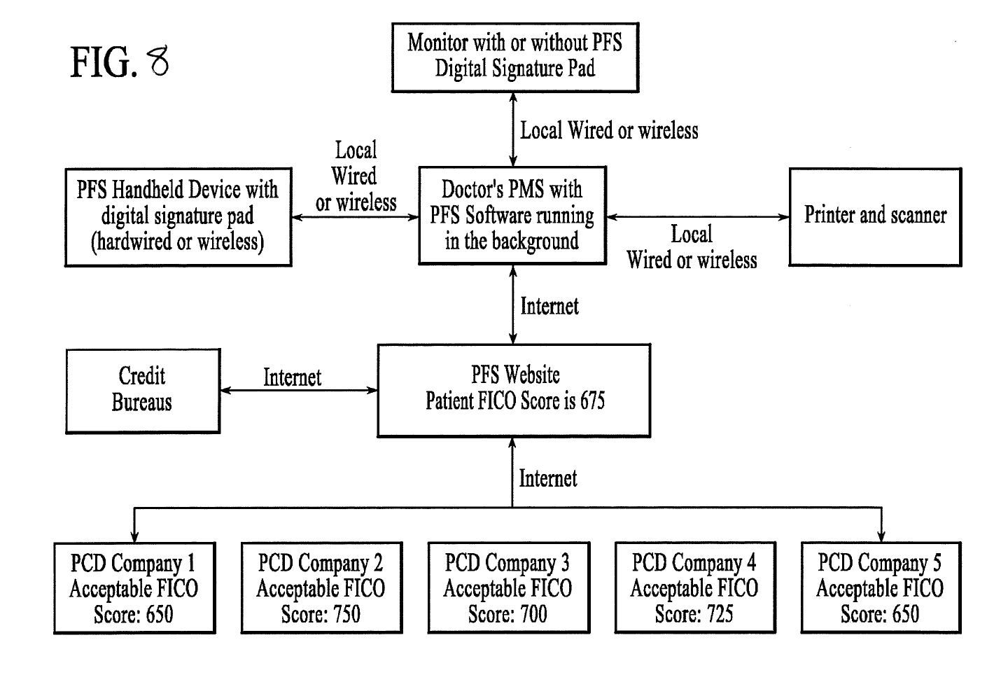

The PFS via the PFS Website can send one PFS CAF with FICO score(s) to one PCD financing company or simultaneously to multiple PCD financing companies. In another scenario, the PFS CAF with FICO score(s) can be selectively sent via the PFS Platform to PCD financing companies wherein the minimum FICO score threshold required to extend credit is known (FICO Score Filtering in FIG. 8). For example, if a PCD financing company is likely to finance a healthcare treatment plan amount up to $10,000 for FICO scores above 675 and a patient has a $4,000 dental procedure to finance with a FICO score of 690, then the PFS would send the PFS CAF to the PCD financing company with FICO funding thresholds of 690 or less (e.g., PCS Companies 1 and 5). If, on the other hand, the patient's FICO score is 640, then PFS will not send the credit application to any of the PCS companies presented and would return a message stating the patient's FICO does not meet the minimum funding level for the PCD financing companies selected.

The PFS Software can reside on the healthcare provider computer system and run in the PMS background. The healthcare provider can also log into the PFS Website via the Internet and run the PFS Software remotely from the Website. When a patient desires to seek third party financing for the $4,000 out-of-pocket costs, then the healthcare provider office administrator clicks on the PFS icon and starts the PFS financing process. Alternatively, the healthcare provider office administrator can be working in the PMS and click the PFS icon and begin working simultaneously and, for example, export the patient name, address, and social security number (if available) from the PMS to the PFS CAF. The healthcare provider information (number) is automatically populated on the PFS CAF.

The PFS Software comprises CAF and credit acceptance form templates corresponding to the PCD financing companies. If the PCD financing company prefers to have the CAF submitted, for example, in a specific format, then the PFS Software maps from the PFS CAF to the PCD financing company CAF.

The patient's information can be exported from the PMS to the PFS CAF where it is used to populate the CAF. Information missing from the PFS CAF can be entered via the computer system or the PFS HHD. The patient reviews the PFS CAF, corrects, updates, or adds any additional information, and signs the PFS CAF using the digital signature pad. After signature, the PFS will prompt the healthcare provider office whether for a number of items prior to sending the PFS CAF to all of the PCD financing companies (Non-Selective Process) or to set filter parameters for Selective Processing.

The PFS CAF with the digital signature is sent via the Internet to the PFS Website with the electronic instructions provided by the healthcare provider office and patient (Non-Selective Processing in this example). The patient name, address, and social security number is sent to the credit bureaus by the PFS Website, and a FICO credit score is returned to the PFS Website and attached to the PFS CAF. Prior to sending the PFS CAF with FICO score to the PCD financing companies, the PFS Platform maps the treatment facility's PFS identification number to the specific PCD financing company's healthcare provider identification number. Each PFD CAF with the specific healthcare provider identification number is sent to the corresponding PCD financing company. Each PCD financing company reviews the patient PFS CAF and returns their decision to the PFS Website, which then securely displays the results at the provider office.

The PFS operations or processes of an embodiment comprise coupling or connecting from the provider office computer system to the PFS Software and/or PFS Website. At the level of the healthcare provider office, the administrator enters the PFS Software and prompts the administrator to select the type of credit application submission (Selective or Non-Selective) via the PFS and populate the PFS CAF. From either the PFS Software or the PMS, the PFS CAF is populated with the patient's name, address, and other information. The PFS CAF is reviewed by the patient and a provider representative, and any additional information is added and amended. Review of the PFS CAF is accomplished by printing the PFS CAF after the patient's data has populated the application and allowing the patient to complete or review the PFS CAF. Upon successful completion of the CAF, the patient uses the PFS Electronic Signature Pad and signs the PFS CAF.

Alternatively, review of the PFS CAF is accomplished using the PFS HHD. The patient completes and reviews the PFS CAF via the PFS HHD. The patient signs the PFS CAF using the PFS HHD once the PFS CAF is completed.

The completed PFS CAF is electronically sent from the healthcare provider via the Internet to the PFS Website. The PFS Website sends the patient name, address, and social security number to the credit bureaus and, in response, the FICO score is returned to the PFS Website and added to the PFS CAF. Before electronically sending the patient PFS CAF to PCD financing companies, the PFS Website Platform completes the PFS CAF by matching and mapping the healthcare provider PFS identification number to the healthcare provider identification number with the PCD financing companies that are to review the patient CAF. In some cases, PCD financing companies prefer to review the CAF using their designated CAF. As such, the PFS Platform/Software or PFS Website can map the patient PFS CAF to a PSC financing company-specific CAF.

The PFS Website transmits the PFS CAF (including patient FICO score, amount to be financed, and healthcare provider identification number) to PCD financing companies. PCD companies review the patient PFS CAF and return their decisions. The PFS Website sends the PCD financing company's decisions to the healthcare provider where they can be viewed via the GUI. The decision from PCD companies would include terms of any financing offered.

The patient, either using the PFS HHD or a computer at the healthcare provider, can select the finance product offered by any of the PCD financing companies approving the patient's credit application. Once selected, the selected provider of consumer debt financing is notified via the PFS. The selected provider of consumer debt financing acknowledges the acceptance and reconciles the financed showing the gross amount financed less fees and discounts (net amount financed). The healthcare provider receives the net amount financed, and the patient receives a statement showing the gross amount financed.

There are numerous variations to the PFS process described herein. For example, the PFS of an embodiment comprises FICO Score Filtering. FIG. 8 is a flow diagram of FICO Score Filtering of the PFS, under an embodiment. Following is an example of FICO Score Filtering under an embodiment. The minimum acceptable FICO score by PCD financing companies can be stored in the PFS Platform. Once the patient FICO score is received at the PFS Platform, the PFS CAF can be selectively sent only to PCD companies for which the patient's FICO score is in the acceptance range. For example, if the patient's FICO score is 675, then the PFS FICO filtering algorithm enables only PCD companies 1 and 5 as the candidate companies that match the patient FICO score with their minimum acceptable FICO score. The FICO Score Filtering can be automatic, or set at the level of the healthcare provider when the PFS CAF is processed and transmitted to PCD financing companies for credit evaluation. The PFS FICO Score Filtering centers on the processing cost at the level of the PCD companies such that patient's that would not quality based on a PCD financing company's threshold acceptance score are not processed by that particular PCD financing company.

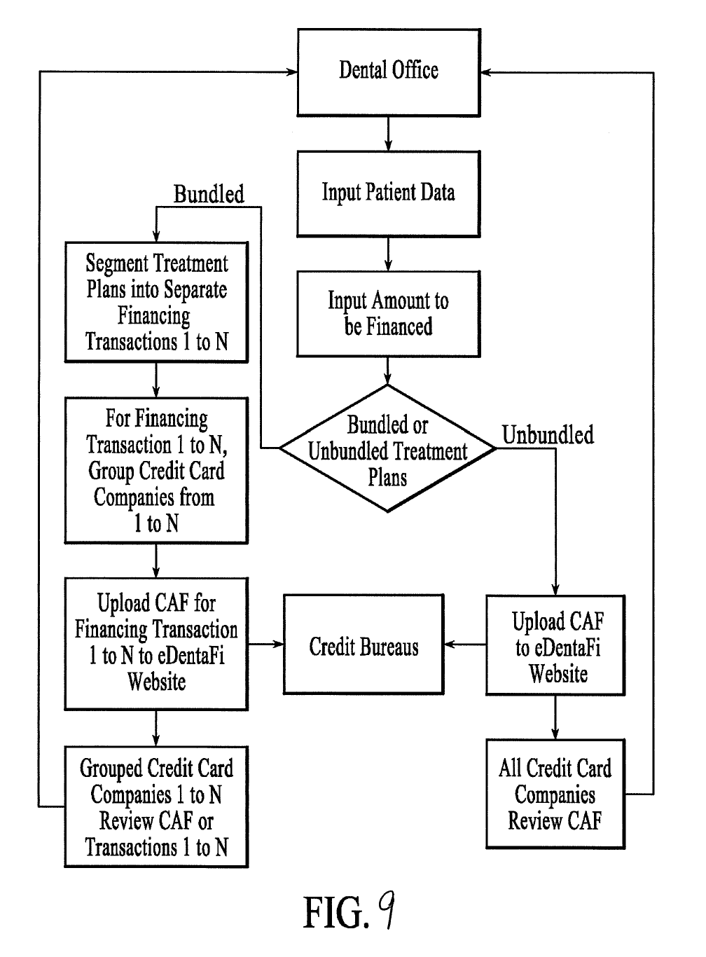

The PFS of an embodiment comprises Selective Standard Submission with Unbundling and FICO Score Filtering. FIG. 9 is a flow diagram of unbundling and selective processing of healthcare treatment plans, under an embodiment. As an example, there are treatment instances when out-of-pocket costs exceed $4,000. For example, partial or full mouth reconstruction using dental implants can cost the patient $25,000, or more with little or no dental insurance coverage. The PFS of an embodiment comprises several different processes for unbundling and processing the patient PFS CAF. For example, the $25,000 procedures can be divided into two dental treatment plans, one for $10,000 and the other for $15,000. The two unbundled treatment plans can be sequentially submitted after presenting the $25,000 dental treatment plan to the patient. After completing the PFS CAF for the $10,000 of the unbundled $25,000 treatment plan, the patient's PFS CAF is processed. The Selective process can be used under which specific PCD financing companies selected, but the embodiment is not so limited.

Alternatively, the FICO can be procured and the FICO Score Filter process can be selected and modified by selecting the specific PCD financing companies to which the $10,000 credit application is submitted (Modified FICO Score Filtering). In this example, the Modified the FICO Score Filtering process is invoked. Accordingly, the patient FICO is procured, matched with PCD financing companies wherein the FICO score meets or exceeds the PCD companies' threshold FICO score, and this result returned to the healthcare provider for evaluation and selection. The healthcare provider selects a set of PCD financing companies to submit the patient's $10,000 credit application. The patient's CAF is processed via the PFS and the results returned to the healthcare provider for evaluation by the healthcare provider and/or patient.

Once the credit application process for the unbundled $10,000 dental treatment plan is completed, the unbundled $15,000 dental treatment can be submitted. When submitting the $15,000 dental plan for financing, the patient and/or dental office would select a different set of PCD financing companies to review the credit application when compared to the unbundled $10,000 credit application. In summary, if a PCD financing company finances the $10,000 dental treatment plan, then the second unbundled $15,000 treatment plan of the $25,000 dental treatment plan is processed using the FICO Score Filter and a set of prospective PCD financing companies that are manually selected to be different from the PCD financing companies evaluating the unbundled $10,000 dental treatment plan. The $15,000 dental treatment plan is evaluated by the proposed PCD financing companies and the decision returned.

In some cases, PCD financing companies ay openly and/or competitively bid on the financing of healthcare procedures for certain patients. The patient PFS CAF with the FICO score is posted securely on the PFS Website to be viewed by PCD financing companies. The PFS Website, via connectivity to PCD financing companies, is configured to facilitate a bidding process for terms to provide financing, and the most attractive financing terms can be considered and/or selected by the patient.

In some cases, PCD financing companies may elect not to participate (opt out) in the PFS process to finance healthcare procedures. The PFS Website can connect to the PCD financing company opting out and send the PFS CAF with or without the patient FICO score.

An element of the PFS (or DCDRC) includes, but is not limited to, completing the DCDRC patient application in the provider office. The CAF of the PFS can be entered digitally by the patient at a computer terminal or completed using a paper application. At times, the provider office has the patient information in digital format (for example, in the case of a practice management system integration) and can be imported. Using this method, the patient reviews the CAF and signs the electronic application using the digital signature pad or digital signature feature in the PFS. If the CAF is paper, provider office personnel manually enter the information into the computer. The patient reviews the CAF for correctness and uses a digital signature pad to sign the DCDRC application.

Completed CAFs are transmitted electronically to the Platform via the web portal where they are accessible by the provider office. The CAF is submitted to the portal aggregating providers of consumer debt. The Platform submits certain aspects of the CAF the credit agencies to procure the patient's FICO score. After the patient's credit worthiness is scored, the CAF is submitted through the Platform to the portal aggregating providers of consumer debt.

Providers of consumer debt review the patient's CAF and respond to the provider office via the Platform. The patient selects a financing option from a menu of financing products approved by the provider(s) of consumer debt. The selected finance product is returned to the selected provider of debt via the Platform.

Funding of the provider treatment plan or procedure is provided and electronically transferred to the provider account directly or in the Platform. The corresponding credit card and statement is sent directly to the patient from the provider of consumer debt financing.

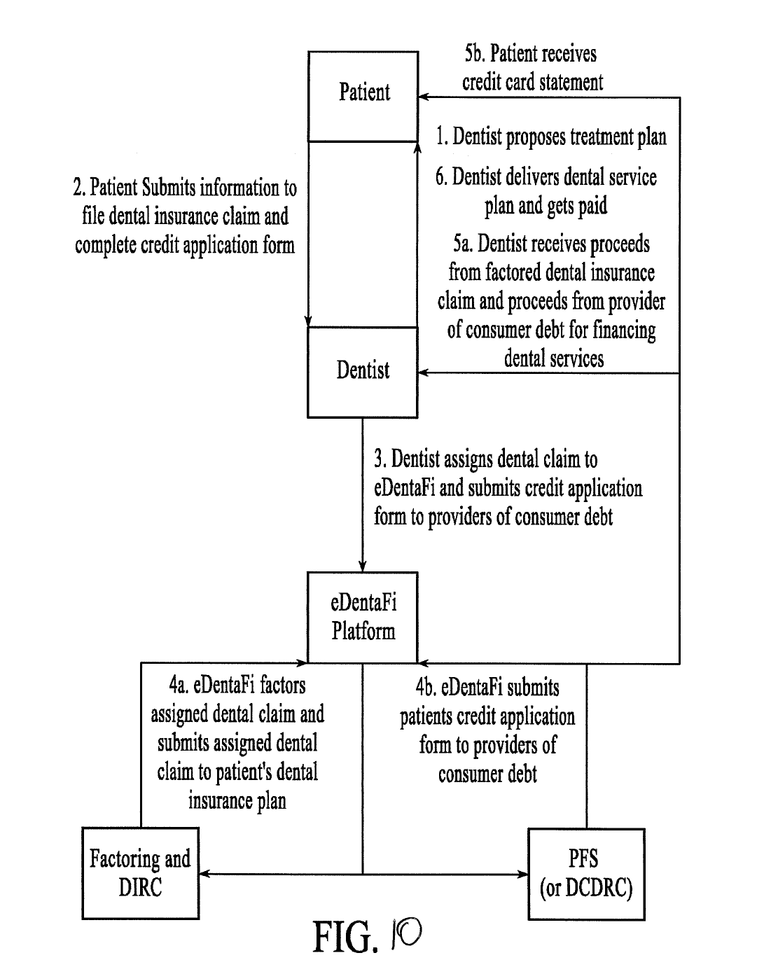

FIG. 10 is a block diagram of the dentist using the eDentaFi platform to facilitate the delivery of dental services by factoring the assign dental claim and seeking patient financing for the proposed dental treatment plan through the PFS enabled by the eDentaFi platform, under an embodiment. The combined DIRC and PFS simultaneously process dental insurance and patient financing. The eDentaFi platform is electronically coupled to one or more computers or systems at a treatment facility (e.g., doctor) and a DIRC platform and a DCDRC platform. In an alternative embodiment, a patient using a personal computer may be provided access to the eDentaFi platform. The coupling includes any type or combination of network technologies.

Provider offices can integrate the PFS Platform into the provider practice via a subscription or per use fee. The PFS can run or be accessed in the background of provider practice management systems or other products, via a web portal, and /or as a stand-alone offering.

Embodiments described herein include a system comprising a platform including a processor running platform software. The platform software is configured to receive provider data from a plurality of providers. The plurality of providers includes a plurality of healthcare providers, and the provider data from each provider includes patient account data corresponding to a plurality of patients, and provider financial parameters. The platform software is configured to receive financial data from a plurality of financial entities. The financial data from each entity includes financial product data, and qualification parameters. The platform software is configured to generate aggregated data by aggregating the provider data from the plurality of providers, and the financial data from the plurality of financial entities. The platform software is configured to determine from the aggregated data a set of patients. Each patient of the set of patients corresponds to an account balance with a healthcare provider. The plurality of patients includes the set of patients. The platform software is configured to generate from the aggregated data at least one settlement option for resolving each account balance of the set of patients. The at least one settlement option includes at least one of a payment option and a financing option. The financial product data comprises the at least one settlement option. The platform software is configured to control access by the set of patients to the at least one settlement option and corresponding financial entities of the plurality of financial entities.

Embodiments include a system comprising a platform including a processor running platform software configured to; receive provider data from a plurality of providers, wherein the plurality of providers include a plurality of healthcare providers, and the provider data from each provider includes patient account data corresponding to a plurality of patients, and provider financial parameters; receive financial data from a plurality of financial entities, wherein the financial data from each entity includes financial product data, and qualification parameters; generate aggregated data by aggregating the provider data from the plurality of providers, and the financial data from the plurality of financial entities; determine from the aggregated data a set of patients, wherein each patient of the set of patients corresponds to an account balance with a healthcare provider, wherein the plurality of patients includes the set of patients; generate from the aggregated data at least one settlement option for resolving each account balance of the set of patients, wherein the at least one settlement option includes at least one of a payment option and a financing option, wherein the financial product data comprises the at least one settlement option; and control access by the set of patients to the at least one settlement option and corresponding financial entities of the plurality of financial entities.

The patient financial data of each patient includes at least one of name, current address, past address, date of birth, employment data, income data, Social Security number, identification card number provider reference number, and insurance identification data.

The patient account data includes account identification data, account balance data, and aging data, wherein the account balance data includes current account balance, prospective account balance, past due account balance, and bad debt account balance.

The plurality of financial entities includes financial institutions that provide financial services and financial products.

The platform software is configured to generate and transmit a notification to each patient of the set of patients, wherein content of the notification includes a patient identifier, an account balance, a provider corresponding to the account balance, and the at least one settlement option.

The platform software is configured to control a patient portal configured to be accessed by the plurality of patients, wherein access to the at least one settlement option and corresponding financial entities of the plurality of financial entities is controlled via the patient portal.

The account balance, provider corresponding to the account balance, and the at least one settlement option are provided to each corresponding patient of the set of patients via the patient portal.

The platform software is configured to receive the patient financial data via the patient portal.

In response to receipt of the patient financial data from a patient, the platform software is configured to return at least one account balance corresponding to the patient.

In response to receipt of the patient financial data, the platform software is configured to generate a comparison between the patient financial data and the financial data.

The platform software is configured to determine credit worthiness of each patient using the patient financial data, wherein the comparison includes the credit worthiness.

The platform software is configured to exchange data with a plurality of credit reporting agencies.

The platform is configured to generate the at least one settlement option in response to a result of the comparison.

The platform software is configured to control selection by a patient of the at least one settlement option.

In response to receiving data of selection of the at least one settlement option, the platform software is configured to provide a notification of additional data needed to secure the at least one settlement option, and receive the additional data via the patient portal.

The platform software is configured to direct proceeds of the selected at least one settlement option to at least one of a provider and a patient corresponding to the account balance.

The platform software is configured to direct proceeds of the selected at least one settlement option to a medical savings account corresponding to a patient.

The platform software is configured for use in directing payment of funds from a medical savings account to a provider.

The platform software is configured for use in at least one of selecting and establishing a medical savings account.

The platform software is configured to separately control access to the plurality of financial entities by each of the plurality of patients in response to a result of the comparison.

The access includes access to financial services of the plurality of financial entities.

The access includes access to a medical savings account.

In the description above, numerous specific details are introduced to provide a thorough understanding of, and enabling description for, embodiments of the platform. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

The systems and methods described herein include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of a host system, and/or provided by some combination of algorithms. The methods described herein can be implemented in one or more of software algorithm(s), programs, firmware, hardware, components, circuitry, in any combination.

System components embodying the systems and methods described herein can be located together or in separate locations. Consequently, system components embodying the systems and methods described herein can be components of a single system, multiple systems, and/or geographically separate systems. These components can also be subcomponents or subsystems of a single system, multiple systems, and/or geographically separate systems. These components can be coupled to one or more other components of a host system or a system coupled to the host system.

Communication paths couple the system components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the platform is not intended to be exhaustive or to limit the systems and methods described to the precise form disclosed. While specific embodiments of, and examples for, the platform are described herein for illustrative purposes, various equivalent modifications are possible within the scope of other systems and methods, as those skilled in the relevant art will recognize. The teachings of the platform provided herein can be applied to other processing systems and methods, not only for the systems and methods described above.

The elements and acts of the various embodiments described above can be combined to provide further embodiments. These and other changes can be made to the platform in light of the above detailed description.

The elements and acts of the various embodiments described above can be combined to provide further embodiments. These and other changes can be made to the embodiments described above in light of the above detailed description.

In general, in the following claims, the terms used should not be construed to limit the embodiments described above to the specific embodiments disclosed in the specification and the claims, but should be construed to include all systems that operate under the claims. Accordingly, the embodiments described above are not limited by the disclosure, but instead the scope is to be determined entirely by the claims.

While certain aspects of the embodiments described above are presented below in certain claim forms, the inventors contemplate the various aspects of the embodiments described above in any number of claim forms. Accordingly, the inventors reserve the right to add additional claims after filing the application to pursue such additional claim forms for other aspects of the embodiments described above.

What is claimed is:

1. A system comprising:
a platform including a processor running platform software configured to;
receive provider data from a plurality of providers, wherein the plurality of providers include a plurality of healthcare providers, and the provider data from each provider includes patient account data corresponding to a plurality of patients, and provider financial parameters;
receive financial data from a plurality of financial entities, wherein the financial data from each entity includes financial product data, and qualification parameters;
generate aggregated data by aggregating the provider data from the plurality of providers, and the financial data from the plurality of financial entities;
determine from the aggregated data a set of patients, wherein each patient of the set of patients corresponds to an account balance with a healthcare provider, wherein the plurality of patients includes the set of patients;
generate from the aggregated data at least one settlement option for resolving each account balance of the set of patients, wherein the at least one settlement option includes at least one of a payment option and a financing option, wherein the financial product data comprises the at least one settlement option; and
control access by the set of patients to the at least one settlement option and corresponding financial entities of the plurality of financial entities.

2. The system of claim 1, wherein the patient financial data of each patient includes at least one of name, current address, past address, date of birth, employment data, income data, Social Security number, identification card number provider reference number, and insurance identification data.

3. The system of claim 1, wherein the patient account data includes account identification data, account balance data, and aging data, wherein the account balance data includes current account balance, prospective account balance, past due account balance, and bad debt account balance.

4. The system of claim 1, wherein the plurality of financial entities includes financial institutions that provide financial services and financial products.

5. The system of claim 1, wherein the platform software is configured to generate and transmit a notification to each patient of the set of patients, wherein content of the notification includes a patient identifier, an account balance, a provider corresponding to the account balance, and the at least one settlement option.

6. The system of claim 1, wherein the platform software is configured to control a patient portal configured to be accessed by the plurality of patients, wherein access to the at least one settlement option and corresponding financial entities of the plurality of financial entities is controlled via the patient portal.

7. The system of claim 6, wherein the account balance, provider corresponding to the account balance, and the at least one settlement option are provided to each corresponding patient of the set of patients via the patient portal.

8. The system of claim 1, wherein the platform software is configured to receive the patient financial data via the patient portal.

9. The system of claim 8, wherein, in response to receipt of the patient financial data from a patient, the platform software is configured to return at least one account balance corresponding to the patient.

10. The system of claim 9, wherein, in response to receipt of the patient financial data, the platform software is configured to generate a comparison between the patient financial data and the financial data.

11. The system of claim 10, wherein the platform software is configured to determine credit worthiness of each patient using the patient financial data, wherein the comparison includes the credit worthiness.

12. The system of claim 11, wherein the platform software is configured to exchange data with a plurality of credit reporting agencies.

13. The system of claim 10, wherein the platform is configured to generate the at least one settlement option in response to a result of the comparison.

14. The system of claim 13, wherein the platform software is configured to control selection by a patient of the at least one settlement option.

15. The system of claim 14, wherein, in response to receiving data of selection of the at least one settlement option, the platform software is configured to provide a notification of additional data needed to secure the at least one settlement option, and receive the additional data via the patient portal.

16. The system of claim 14, wherein the platform software is configured to direct proceeds of the selected at least one settlement option to at least one of a provider and a patient corresponding to the account balance.

17. The system of claim 16, wherein the platform software is configured to direct proceeds of the selected at least one settlement option to a medical savings account corresponding to a patient.

18. The system of claim 16, wherein the platform software is configured for use in directing payment of funds from a medical savings account to a provider.

19. The system of claim 16, wherein the platform software is configured for use in at least one of selecting and establishing a medical savings account.

20. The system of claim 10, wherein the platform software is configured to separately control access to the plurality of financial entities by each of the plurality of patients in response to a result of the comparison.

21. The system of claim 20, wherein the access includes access to financial services of the plurality of financial entities.

22. The system of claim 20, wherein the access includes access to a medical savings account.
